(19) United States
(12) Patent Application Publication
(10) Pub. No.: US 2025/0351990 A1
(43) Pub. Date: Nov. 20, 2025

(54) METHOD AND DEVICE FOR DISSOLVING OR EMULSIFYING COMPOUNDS FROM A GRANULAR MATERIAL

(71) Applicant: CRE8IC LTD, Stokesley, North Yorkshire (GB)

(72) Inventor: James HOWELL, Stokesley (GB)

(21) Appl. No.: 18/854,379

(22) PCT Filed: Apr. 11, 2023
(86) PCT No.: PCT/EP2023/059433

§ 371 Date: Oct. 4, 2024

(30) Foreign Application Priority Data
Apr. 7, 2022 (EP) 22167215.7
Jun. 23, 2022 (EP) 22180810.8

(51) Int. Cl. A47J 31/22; A47J 31/20

(52) U.S. Cl. CPC A47J 31/22; A47J 31/20

(57) ABSTRACT

The present disclosure relates to a rotational fluidic device and method for efficiently dissolving or emulsifying compounds from granular materials, such as coffee or tea, in both hot and cold brew coffee extraction processes, as well as for infusing beverages like cocktails or other drinks. The inventive method employs a holder for the granular material, a vessel with a specific geometry, and a mechanism for providing rotational motion to the holder, creating a fluidic rotation within the vessel. The fluid rotation enhances the extraction and emulsification process, resulting in improved extraction efficiency, reduced brewing time, and enhanced flavour profiles. The disclosure is versatile, capable of brewing both hot and cold coffee and infusing a variety of beverages, overcoming limitations and drawbacks of traditional brewing and infusion methods.

### CROSS-REFERENCE TO RELATED APPLICATIONS

This application is a U.S. National Phase Application under 35 U.S.C. 371 of International Application No. PCT/EP2023/059433, filed on Apr. 11, 2023, which claims the benefit of European Patent Application No. 22167215.7, filed on Apr. 7, 2022, and European Patent Application No. 22180810.8, filed on Jun. 23, 2022. The entire disclosures of the aforementioned European Patent Applications are incorporated herein by reference.

### FIELD

In the following a method and a device are disclosed for dissolving or emulsifying compounds from a granular material using a fluid in a rotational fluidic device. More specifically, a rotational fluidic device for hot and cold brew coffee extraction and beverage infusion is disclosed, as well as a method for coffee extraction and/or beverage infusion using such device.

### BACKGROUND

This section provides background information related to the present disclosure which is not necessarily prior art.

The method and the device are especially suitable for extracting coffee in a so-called cold brew process. Furthermore, the method is suitable for infusing beverages, like cocktails or drinks.

In principle, the preparation of a coffee or tea beverage from ground coffee beans or tea leaves, respectively, is a process of dissolving and/or emulsifying compounds from a granulated material. Traditional methods for brewing coffee include drip brewing, espresso extraction, and immersion brewing, which involve different techniques of passing water through or holding water around coffee grounds. Cold brewing, a subcategory of immersion brewing, involves steeping coffee grounds in cold or room temperature water for an extended period, typically 12-24 hours. While cold brewing yields a unique flavour profile with reduced bitterness and acidity, it can be time-consuming and may not efficiently extract all desirable compounds from the coffee grounds. In contrast, hot brewing methods can extract compounds more efficiently but may introduce undesirable flavours due to higher extraction temperatures. Beverage infusion techniques, such as those used for cocktails or other drinks, often involve simple mixing or steeping of ingredients, which may not maximise the extraction of flavours and compounds from the ingredients.

### SUMMARY

This section provides a general summary of the disclosure, and is not a comprehensive disclosure of its full scope or all of its features.

It is an object of the present disclosure to address the limitations and drawbacks of conventional coffee brewing and beverage infusion methods.

By utilising a rotational fluidic device, the disclosure provides an efficient and versatile method for extracting compounds from granular materials, such as coffee or tea. The device's unique geometry and rotational motion create a fluidic rotation, which facilitates efficient extraction and emulsification of compounds from the granular material, like e.g. coffee grounds or tea leaves. The disclosure is suitable for both hot and cold brew coffee extraction, offering improved extraction efficiency, reduced brewing time, enhanced flavour profiles, and versatility in brewing temperatures. Additionally, the disclosure can be used for infusing beverages such as cocktails or other drinks, providing improved flavour extraction and infusion capabilities.

The present disclosure provides a rotational fluidic device and method for efficiently dissolving or emulsifying compounds from granular materials, such as coffee or tea, in both hot and cold brew coffee extraction processes, as well as for infusing beverages like cocktails or other drinks. The inventive method employs a holder for the granular material with at least one inlet for receiving fluid into the holder and at least one outlet for discharging fluid from the holder and at least one channel in proximity to said holder. Preferably, a vessel with a specific geometry, such as a conical or square shape, is provided to contain the fluid.

The rotational fluidic device and method for dissolving and/or emulsifying compounds from a granular material, such as coffee or tea, represents a novel approach to beverage extraction. This innovative system uniquely combines the principles of percolation brewing and immersion brewing, offering a distinct set of advantages over traditional brewing methods.

In percolation brewing, water is passed through a bed of granular material, extracting compounds as it flows through. This method ensures efficient extraction and a well-defined flavour profile. On the other hand, immersion brewing involves steeping the granular material in water for an extended period, allowing for a more thorough extraction process, resulting in a richer, more complex flavour.

The rotational fluidic device takes the best of both methods by providing a holder for the granular material with at least one inlet and outlet for fluid movement. As the holder rotates, boundary and/or shear layers are created in the fluid, causing it to move within the at least one channel provided. This movement drives the fluid into the holder through the inlet, effectively percolating the fluid through the granular material. Simultaneously, the same fluid is reused in the process, mimicking the immersion brewing technique. This unique combination ensures efficient extraction, a well-defined flavour profile, and a richer, more complex beverage.

By integrating both percolation and immersion brewing techniques into a single device, the rotational fluidic device offers a versatile and adaptable brewing solution. This innovative method enables users to achieve optimal extraction efficiencies and customise the resulting beverage's flavour and texture, setting it apart from other brewing methods currently available in the market.

The disclosure utilises rotational motion of the holder about an axis, which creates boundary and/or shear layers in the fluid, causing movement of at least a portion of the fluid within the at least one said channel, where said movement causes at least a portion of said fluid to enter the at least one said inlet. This rotational fluidic device enables more efficient extraction and emulsification of compounds from the granular material, resulting in improved extraction efficiency, reduced brewing time, and enhanced flavour profiles.

The disclosure is versatile, capable of brewing both hot and cold coffee, as well as infusing beverages. In one embodiment, the rotational device includes a heater, which can be used to heat the fluid for hot coffee brewing or other applications requiring elevated temperatures. The method and device offer a novel approach to coffee brewing and beverage infusion, overcoming limitations and drawbacks of traditional brewing and infusion methods.

The disclosure especially provides an adaptable and versatile brewing system capable of handling a variety of granular materials, such as coffee, tea, and other infusible substances, by allowing users to customise parameters like rotational speed, temperature, and brewing time.

The disclosure encompasses innovative features, such as impeller geometry in the inlets, aeration of the fluid, and various heating mechanisms, to optimise the extraction or emulsification process and enhance the resulting beverage's flavour profile, texture, and sensory qualities.

The disclosure offers a range of vessel geometries and holder designs, including integrated filters and various valve configurations, to accommodate different extraction techniques and granular materials, improving the overall extraction efficiency and user experience.

The rotational fluidic device and method offer remarkable versatility in beverage extraction and preparation. In addition to traditional water-based extractions, the device can be utilised to extract coffee directly into milk or milk alternatives, such as almond milk, soy milk, or oat milk. This feature allows users to create a wide variety of beverages, including lattes, cappuccinos, and other specialty coffee drinks, using a single extraction process.

One of the notable advantages of the rotational fluidic device is its ability to aerate milk or milk alternatives, creating foam even when the fluid is cold. The device achieves this by generating boundary and/or shear layers in the fluid during the extraction process, incorporating air into the fluid and creating a desirable frothy texture. This aeration enhances the mouthfeel of the resulting beverage, providing a richer and more enjoyable drinking experience.

Furthermore, the rotational fluidic device and method can be adapted to operate under vacuum conditions by incorporating a vacuum pump connected to the vessel. Running the device under vacuum can offer several benefits, such as preventing the formation of foam in beverages where a smoother texture is preferred or improving the extraction efficiency for certain types of granular materials. The vacuum setup provides users with additional control over the extraction process and the ability to customise the texture and flavour profile of the resulting beverage.

In summary, the rotational fluidic device and method present a highly adaptable and versatile brewing solution suitable for creating various beverages, ranging from traditional coffee extractions to specialty drinks with milk or milk alternatives. The device's ability to aerate fluids, as well as the potential to operate under vacuum conditions, opens up a range of possibilities for users to craft unique and personalised beverages, setting it apart from conventional brewing methods.

The disclosure incorporates advanced technologies, such as magnetic or fluid bearings, programmable control systems, and integrated sensor systems, to provide precise control over the extraction or infusion process and ensure consistent, high-quality results.

The disclosure addresses the limitations and drawbacks of traditional brewing and infusion methods by utilising a rotational fluidic device to create a fluidic rotation that enhance the extraction or emulsification process, reducing brewing time and improving the extraction efficiency

### Detailed Description of the Disclosure

The present disclosure describes a rotational fluidic device and method for efficiently dissolving or emulsifying compounds from granular materials, such as coffee or tea. The device is designed for use in hot and cold brew coffee extraction processes and beverage infusion applications, like cocktails or other drinks. The disclosure consists of a holder for the granular material, a vessel with a specific geometry, and a mechanism for providing rotational motion to the holder. The rotational motion creates a fluidic rotation within the vessel, facilitating efficient extraction and emulsification of compounds from the granular material.

The rotational fluidic device and method enable efficient extraction or emulsification of compounds from various granular materials, addressing the limitations of traditional brewing and infusion methods and offering improved extraction efficiency, reduced brewing time, and enhanced flavour profiles.

According to a preferred embodiment, the disclosure incorporates a unique combination of holder design, vessel geometry, and rotational motion, creating a fluidic rotation that enhances the contact between the fluid and granular material, optimising the extraction or emulsification process for a wide range of applications.

The rotational fluidic device provides a highly customizable brewing system, allowing users to adjust various parameters, such as rotational speed, temperature, and brewing time, to achieve their desired flavour profiles, extraction efficiencies, and beverage textures.

The disclosure features innovative technologies, such as magnetic or fluid bearings, impeller geometry in the inlets, programmable control systems, and integrated sensor systems, contributing to precise control over the extraction or infusion process and ensuring consistent, high-quality results.

The rotational fluidic device offers a versatile brewing solution suitable for both hot and cold coffee extraction processes, as well as for infusing beverages like cocktails or other drinks, making it a valuable addition to both commercial and home settings.

### Embodiments

Various embodiments of the disclosure can be implemented with different geometries for the vessel, such as conical or square shapes, with optional ribs. The rotational motion of the holder can be driven by a magnetic coupled drive mechanism, a direct drive, or a time-varying magnetic field. The fluid used in the extraction or infusion process can be water or another suitable liquid. In some embodiments, the rotational fluidic device includes a heater, such as an inductive heater, to heat the fluid for hot coffee brewing or other temperature-sensitive applications.

According to another embodiment of the method, the rotational fluidic device includes a programmable control system for adjusting parameters such as rotational speed, temperature, and brewing time, allowing users to customise the extraction or infusion process to their preferences.

According to another embodiment of the method, the rotational fluidic device comprises a removable and replaceable holder, enabling easy cleaning and maintenance, as well as the possibility to use different holder designs or sizes for various granular materials or brewing techniques.

According to another embodiment of the method, the rotational fluidic device includes a built-in cooling mechanism, allowing for rapid cooling of the fluid after hot brewing or maintaining low temperatures during cold brewing processes.

According to another embodiment of the method, the vessel and holder are transparent or semi-transparent, providing users with a visual representation of the extraction or infusion process and allowing for the monitoring of the fluidic rotation formation.

According to another embodiment of the method, the rotational fluidic device includes an integrated sensor system to measure parameters such as fluid temperature, pressure, and flow rate, providing real-time feedback for optimising the extraction or infusion process.

According to another embodiment of the method, the rotational fluidic device incorporates a modular design, allowing users to easily switch between different vessel geometries, holders, and drive mechanisms to accommodate a wide range of extraction or infusion applications and techniques.

According to another embodiment of the method, the rotational fluidic device includes an automatic shut-off feature that stops the rotation of the holder when the desired extraction or infusion time has elapsed, ensuring consistent results.

According to another embodiment of the method, the rotational fluidic device features a user-friendly interface, such as a touch screen or physical buttons, for easy operation and control of the extraction or infusion process.

### Components and Their Interactions

The holder for the granular material is designed with at least one inlet for receiving fluid into the material and at least one outlet for discharging fluid from the material. The rotational motion of the holder creates boundary and shear layers in the fluid, resulting in a fluidic rotation within the vessel. This rotation enhances the extraction and emulsification process by increasing the contact between the fluid and granular material, while also providing effective mixing and agitation.

Inlets and Impeller Geometry: In some embodiments, the inlets of the holder have an impeller geometry designed to drive the fluid into the holder more efficiently. This impeller geometry can enhance the extraction or emulsification process by optimising the fluid flow through the granular material, maximising the contact between the fluid and granular material.

Pressure Regulation: In certain embodiments, the rotational fluidic device is designed to operate under vacuum or at a pressure above ambient pressure, which can affect the extraction or emulsification process. Higher or lower pressures can influence the solubility of compounds in the fluid, allowing for the optimization of the extraction process for specific granular materials or desired outcomes.

According to another embodiment of the method, the rotational fluidic device and method can be adapted to operate under vacuum conditions by incorporating a vacuum pump connected to the vessel. This setup can be used to prevent the formation of foam in beverages where a smoother texture is preferred or to improve the extraction efficiency for certain types of granular materials.

According to another embodiment of the method, the vacuum setup provides additional control over the extraction process and the ability to customise the texture and flavour profile of the resulting beverage, offering users a versatile brewing solution suitable for creating a wide variety of beverages.

Temperature Monitoring: In some embodiments, the rotational fluidic device includes a temperature monitoring system that measures and controls the fluid's temperature during the extraction or infusion process. This feature ensures consistent temperature conditions and enables users to fine-tune the extraction or infusion process for optimal results.

Filtering and Valves: In certain embodiments, the holder wall comprises a filter or is made of a filtering material. This design enables the filtering of the fluid as it passes through the wall of the holder, separating extracted compounds from the granular material. Additionally, some embodiments may include valves in the holder or vessel, which can be activated by rotational speeds or other mechanisms to increase pressure, seal the vessel at stop, or control fluid flow.

Aeration and Mouthfeel: In some embodiments, the fluid is aerated, either by incorporating gas, such as nitrogen, or by creating foam during the extraction or infusion process. This aeration can change the mouthfeel of the resulting beverage, adding a unique texture or enhancing its sensory qualities.

According to another embodiment of the method, the fluid used for extraction is milk or a milk alternative, such as almond milk, soy milk, or oat milk, enabling the direct extraction of coffee into the fluid to create beverages like lattes, cappuccinos, and other specialty coffee drinks.

According to another embodiment of the method, the rotational fluidic device is utilised to aerate milk or milk alternatives, creating foam even when the fluid is cold, enhancing the mouthfeel of the resulting beverage and providing a richer and more enjoyable drinking experience.

Bearings and Drive Arrangement: In certain embodiments, the rotational fluidic device utilises fluid, magnetic, or other types of bearings for the holder, improving the efficiency and stability of the rotational motion. Additionally, the drive mechanism for the holder can be arranged above or below the holder, depending on the specific design of the rotational fluidic device.

### Operation

To use the rotational fluidic device, the granular material is placed in the holder, and the vessel is filled with the appropriate fluid. The holder is then rotated about its axis, creating fluidic rotation within the vessel. The specific geometry of the vessel causes the fluid enter the holder's inlet and pass through the granular material. The fluid extracts or emulsifies compounds from the granular material as it passes through, before being discharged from the outlet. In hot brewing applications, the heater can be activated to heat the fluid before or during the extraction process.

By leveraging the fluidic rotation created by the rotational motion and vessel geometry, the disclosure offers improved extraction efficiency, reduced brewing time, and enhanced flavour profiles in both hot and cold coffee brewing processes. The rotational fluidic device can also be used for infusing beverages, providing a versatile solution for a wide range of extraction and infusion applications.

Balancing the Granular Material: In some embodiments, the method includes a process to rotationally balance the granular material in the holder. Proper balancing ensures uniform extraction or emulsification and reduces wear on the device's components due to uneven distribution of forces during the rotational motion.

Fluid Flow Control: In certain embodiments, the rotational fluidic device is designed with inlet and/or outlet valves, allowing users to control the fluid flow into and out of the holder during the extraction or infusion process. These valves can be manually or automatically controlled, optimising the fluid flow for different granular materials or desired outcomes.

Draining and Dispensing: In some embodiments, the rotational fluidic device features a draining valve, such as a tap-like draining valve, for easy dispensing of the extracted or infused fluid. This feature simplifies the process of transferring the fluid to another container or serving vessel and allows for convenient and mess-free operation.

Shear Force Heating: In certain embodiments, shear forces generated by the fluidic rotation are used to heat the fluid during the extraction or infusion process. This method of heating the fluid can provide precise temperature control and energy-efficient operation.

Customisable Extraction Parameters: In some embodiments, the rotational fluidic device allows users to adjust various extraction parameters, such as rotational speed, temperature, and brewing time, to achieve their desired flavour profiles and extraction efficiencies. This customisation enables users to fine-tune the extraction or infusion process for different granular materials, personal preferences, or specific applications.

What is disclosed is a method for dissolving and/or emulsifying compounds from a granular material using a fluid in a rotational fluidic device, the method comprising: providing a holder for said granular material, which holder has at least one inlet for receiving said fluid into at least a portion of said granular material and at least one outlet for discharging said fluid from at least a portion of said granular material; providing a vessel of a specific geometry to contain said fluid; providing at least one channel in proximity to said holder; providing rotational motion of said holder about an axis, wherein (a) said motion creates boundary and shear layers in said fluid, causing movement of at least a portion of said fluid within the at least one said channel; and (b) said movement causes at least a portion of said fluid to enter the at least one said inlet.

According to an embodiment of the method the drives are towards the axis of rotation.

According to another embodiment of the method a device is used where said at least one channel is part of vessel.

According to another embodiment of the method a device is used where said at least one channel is below the holder.

According to another embodiment of the method a device is used where said at least one channel forms part of the lid. Preferably, said lid is inverted during use.

According to another embodiment of the method a device is used where said at least one channel is a spiral.

According to another embodiment of the method a device is used having multiple spiral paths.

According to another embodiment of the method a device is used comprising a fluted screw around the axis in the holder forming an impeller geometry.

According to another embodiment of the method a device is used comprising at least one battery as a power source.

According to another embodiment of the method where a rotational motion of the holder in reverse direction allows at least a portion of said fluid to be drained from at least a portion of said granular material. Preferably, in such embodiment backflow of the fluid into the holder is significantly avoided by the reversed rotational motion. It is assumed that a motion in the reverse direction (a) creates boundary and shear layers in said fluid, causing movement of at least a portion of said fluid within the at least one said channel; and (b) said movement completely or partially inhibits at least a portion of said fluid entering the at least one said inlet.

According to an embodiment of the method the specific geometry of the vessel is conical vessel, preferably with ribs.

According to another embodiment of the method the specific geometry of the vessel is a square, optionally comprising ribs.

According to another embodiment of the method the motion is caused by a magnetic coupled drive mechanism.

According to another embodiment of the method the motion is caused by a direct drive.

According to another embodiment of the method the motion is caused by a time varying magnetic field.

According to another embodiment of the method the fluid is water.

According to another embodiment of the method the granular material is coffee or tea.

According to another embodiment of the method the inlets have impeller geometry, preferably to drive in at least a portion of said fluid. Hence, the method comprising the step of driving in the fluid into the holder by an impeller geometry of said inlet.

According to another embodiment of the method the vessel is under vacuum.

According to another embodiment of the method the vessel is partially filled.

According to another embodiment of the method the holder is rotated in a range between ≥500 rpm and ≤10,000 rpm, preferably between ≥1,000 rpm and ≤7500 rpm, more preferably between ≥2,000 rpm and ≤6000 rpm.

According to another embodiment of the method the rotational fluidic device comprises a heater and the fluid is heated by said heater.

According to another embodiment of the method the rotational fluidic device comprises a heater and the fluid is heated by said heater, wherein the heater is an inductive heater.

According to another embodiment of the method the holder wall is and/or comprises a filter. Hence, the method comprises the step of filtering the fluid through the wall of the holder.

According to another embodiment of the method wherein the inlet is in the top of the holder.

According to another embodiment of the method where the fluid pressure around material is increased above ambient pressure.

According to another embodiment of the method where rotational has a velocity in the range of between >0 m/s and ≤250 m/s, preferably between ≥0.5 m/s and ≤150 m/s, more preferably between ≥1 m/s and ≤ 100 m/s.

According to another embodiment of the method a rotational fluidic device is used where the drive is integrated below a countertop.

According to another embodiment of the method it comprises a process to rotationally balance the granular material in the holder.

According to another embodiment of the method a rotational fluidic device is used where fluid forms or is at least part of the bearing of the holder.

According to another embodiment of the method a rotational fluidic device is used comprising a magnetic bearing for the holder.

According to another embodiment of the method a rotational fluidic device is used where the drive is arranged above the holder, i.e. in direction of gravity the holder is arranged underneath the drive.

According to another embodiment of the method a rotational fluidic device is used where the drive is arranged below the holder, i.e. in direction of gravity the holder is arranged above the drive.

According to another embodiment of the method a rotational fluidic device is used wherein a geometry is fixed in the centre diverting some flow of the fluid.

According to another embodiment of the method a rotational fluidic device is used wherein the holder contains valves to increase pressure and/or seal the vessel at stop. According to an embodiment, the valves are activated by rotational speeds.

According to another embodiment of the method the fluid is aerated to create foam and/or changing mouthfeel of a beverage produced by the method.

According to another embodiment of the method the fluid is aerated by adding gaseous nitrogen.

According to another embodiment of the method a rotational fluidic device is used wherein the vessel has inlet and/or outlet valves.

According to another embodiment of the method a rotational fluidic device is used wherein the vessel has a draining valve, preferably a tap-like draining valve.

According to another embodiment of the method, shear forces are used to heat the fluid.

According to another embodiment of the method the temperature is monitored.

With respect to the rotational fluidic device for dissolving and/or emulsifying compounds from a granular material, the disclosure discloses a device comprising a vessel and a holder; wherein the vessel is capable of holding a liquid and the holder is capable of holding the granular material and wherein the holder is arranged within the vessel; wherein the holder comprises at least one inlet for receiving said fluid into at least a portion of said granular material and at least one outlet for discharging said fluid from at least a portion of said granular material; wherein the vessel has a specific geometry to contain said fluid; wherein the holder is capable to be put in rotational motion about an axis, wherein said; and wherein said specific geometry causes at least a portion of said fluid to cascade.

According to an embodiment of the rotational fluidic device, the specific geometry of the vessel is conical, optionally comprising ribs. A conical geometry in the meaning of the disclosure preferably refers to a shape that tapers smoothly from a flat base, preferably circular or squared, to a point called the apex or vertex. The base of the cone may be a circle, any one-dimensional quadratic form in the plane, any closed one-dimensional figure. The axis of a cone is the straight line passing through the apex, about which the base (and the whole cone) has a circular symmetry. The optional ribs may support any fluid rotated within the vessel to form a fluid rotational which moves essentially around the axis of the conical geometry of the vessel and cascades towards said axis.

According to another embodiment of the rotational fluidic device, the specific geometry of the vessel is a square, optionally comprising ribs.

According to another embodiment of the rotational fluidic device the holder is magnetically coupled to a drive mechanism and the motion of the holder is caused by said magnetic coupled drive mechanism. Such magnetic coupling enables easy access to the holder, i.e. enables to easily extract and/or replace the holder from the vessel.

According to another embodiment of the rotational fluidic device, the motion is caused by a time varying magnetic field.

According to another embodiment of the rotational fluidic device, the drive mechanism is a direct drive mechanism, and the motion is caused by said direct drive.

According to another embodiment of the rotational fluidic device, the inlets have impeller geometry. By such impeller geometry the inlets are capable to drive fluid into the holder.

According to another embodiment of the rotational fluidic device, the vessel is capable to hold at least a partial vacuum. The application of a vacuum, i.e. a internal pressure within the vessel below the atmospheric pressure, the extraction can be more effective since gaseous components enclosed in the granulated material may be forced to outgas, thereby increasing the effect of dissolving and/or emulsifying compounds from the granulated material.

According to another embodiment of the rotational fluidic device, the holder is capable to be rotated in a range between ≥500 rpm and ≤10.000 rpm, preferably between ≥1.000 rpm and ≤7500 rpm, more preferably between ≥2.000 rpm and ≤6000 rpm. At this speed of rotation, the fluid entering the holder is effectively pressed towards the inner wall of the holder by centrifugal force.

According to another embodiment of the rotational fluidic device the device comprises a heater capable of heating the fluid. Some compounds to be extracted and/or emulsified from the granular material may have an increased solvability at higher temperature, so that increasing the temperature supports effective extraction of such compounds.

According to another embodiment of the rotational fluidic device the heater is an inductive heater. In a further preferred embodiment, an element heated by the inductive heater may be integrated in the holder so that the fluid is heated at the point of extraction. Alternatively, or in addition, an element heated by the inductive heater may be integrated into the bottom of the vessel and/or into the wall of the vessel.

According to another embodiment of the rotational fluidic device, the holder wall is and/or comprises a filter capable of filtering the fluid through the wall of the holder. In a further embodiment that filter can be formed by a mesh or porous design of the wall of the holder. Preferably, the mesh size and/or size of the pores is in the range of between ≥1.5 μm to ≤40 μm, more preferably between ≥3 μm to ≤30 μm, like e.g. between ≥5 μm to ≤20 μm.

According to another embodiment of the rotational fluidic device, the inlet is in the top of the holder.

According to another embodiment of the rotational fluidic device, the vessel is capable of holding a pressure increased above ambient pressure. By increasing the pressure within the vessel the extraction and/or emulsification of compounds from the granular material can be supported.

According to another embodiment of the rotational fluidic device, the fluid forms or is at least part of the bearing of the holder. When using the as at least partial bearing of the holder a friction reduced bearing of the holder can be established. Furthermore, when used in combination with other bearings like e.g. mechanical bearings, the fluid may support the cooling of the bearing, when frictional forces may result in a heating of the bearing.

According to another embodiment of the rotational fluidic device, the device comprises a magnetic bearing for the holder. In a further preferred embodiment, the bearing is part of the magnetic drive of the holder.

According to another embodiment of the rotational fluidic device, the drive is arranged above the holder, i.e. in direction of gravity the holder is arranged underneath the drive. In such embodiment the drive may form a part or may be integrated into a cap which covers the vessel and prevents liquid to leak uncontrolled.

According to another embodiment of the rotational fluidic device, the drive is arranged below the holder, i.e. in direction of gravity the holder is arranged above the drive. In such embodiment, the drive may form a part or may be integrated in a support holding the vessel.

According to another embodiment of the rotational fluidic device, the drive is integrated below a countertop. In such an embodiment the countertop surface may follow the principle of a clean desk which eases workflows and processes especially in a professional environment, like a coffee shop, restaurant or bar.

According to another embodiment of the rotational fluidic device, a geometry is fixed in the centre diverting some flow of the fluid. By such a geometry the flow of the fluid can be directed towards the inlet of the holder.

According to another embodiment of the rotational fluidic device, the holder contains at least one valves to increase pressure and/or seal the holder from the vessel at stop. Such valve for example may be in the form of a ventricular valve or a flap valve. Preferably, the valve is activated by rotational speeds.

According to another embodiment of the rotational fluidic device, the vessel has inlet and/or outlet valves. Such embodiment eases the filling and draining of the fluid into or from the vessel. Preferably, the vessel has a draining valve, preferably a tap-like draining valve.

According to another embodiment of the rotational fluidic device, the vessel comprises a gas inlet to aerate the fluid. Such inlet may be in the form of a nozzle to support aeration of the fluid.

According to another embodiment of the rotational fluidic device, the device comprises means to monitor the temperature of the fluid and/or the granular material. Such means may be formed by a thermal sensor or an IR sensor. Preferably, such sensors are electronically connected to a central processing and/or data storage unit. Said unit may additionally at least control the drive and/or the heating device. Preferably, the central processing unit is capable of controlling the rotational fluidic device in order to operate according to a workflow. Such workflow may comprise a rotational speed program, temperature program, and/or aeration or pressure program.

### DRAWINGS

The drawings described herein are for illustrative purposes only of selected embodiment(s) and not all possible implementations, and are not intended to limit the scope of the present disclosure.

Embodiments and parts of a device capable to perform the method are depicted in the figures.

FIG. 1 shows a lid with a spiral of a vessel usable for performing the method.

FIG. 2 shows a view inside the lid shown in FIG. 1.

FIG. 3 shows a magnetic holder lid for a holder usable for performing the method, said magnetic holder lid having a centre impeller portion.

FIG. 4 shows another perspective of the holder lid shown in FIG. 3.

FIG. 5 shows the holder lid as shown in FIGS. 3 and 4 placed in the lid shown in FIGS. 1 and 2.

FIG. 6 shows a spiral lid as shown in FIGS. 1 and 2 together with the holder lid as shown in FIGS. 3 and 4.

FIG. 7 shows a holder usable for performing the method with the magnetic holder lid placed on top in an upside-down position.

FIG. 8 shows the holder as shown in FIG. 5 in an upright position with the magnetic holder lid at the bottom.

FIG. 9 shows the holder and the magnetic holder lid as shown in FIGS. 7 and 8 taken apart.

FIG. 10 shows the magnetic holder lid as shown in FIGS. 3 and 4 with a fluid guiding dome above the centre impeller portion.

FIG. 11 shows an inside view into a holder usable for performing the method. FIG. 12 shows a device usable for performing the method, including a drive unit and a control unit.

FIG. 13 shows a vessel usable to perform the method with a holder placed inside the vessel.

FIG. 14 shows an alternative view of the elements depicted in FIG. 6.

FIG. 15 shows an alternative view of the element depicted in FIGS. 3 and 4.

FIG. 16 shows a cross-sectional view of a holder usable to perform the method.

FIG. 17 shows an isometric cross-sectional view of the holder as shown in FIG. 15.

Corresponding reference numerals indicate corresponding parts throughout the view of the drawings.

### DETAILED DESCRIPTION

Example embodiment(s) will now be described more fully with reference to the accompanying drawings.

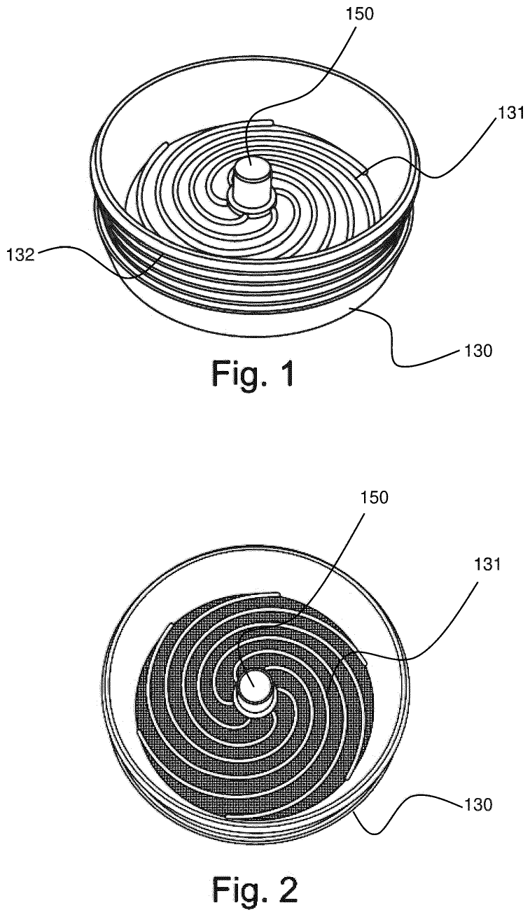

FIG. 1 shows a vessel lid 130 of a vessel 110 of the rotational fluidic device with spiral elements 131 usable for performing the method. Said vessel lid 130 also comprises a bearing 150 for a holder. The bearing 150 can be a magnetic bearing which interacts with a corresponding bearing element of the holder by magnetic forces. In addition, fluid may act as additional bearing to the holder, thereby providing cooling to avoid overheating of the bearing by friction. The vessel lid 130 comprises an external threat 132 which interacts with a respective internal thread of the vessel to fixate the vessel lid 130 to the vessel.

FIG. 2 shows a view inside the vessel lid 130 shown in FIG. 1. In the centre of the circular vessel lid 130 the magnetic bearing 150 is arranged. Spiral elements 131 for directing the fluid are arranged at the bottom of the lid 130. Said spiral elements 131 may guide the fluid into the holder.

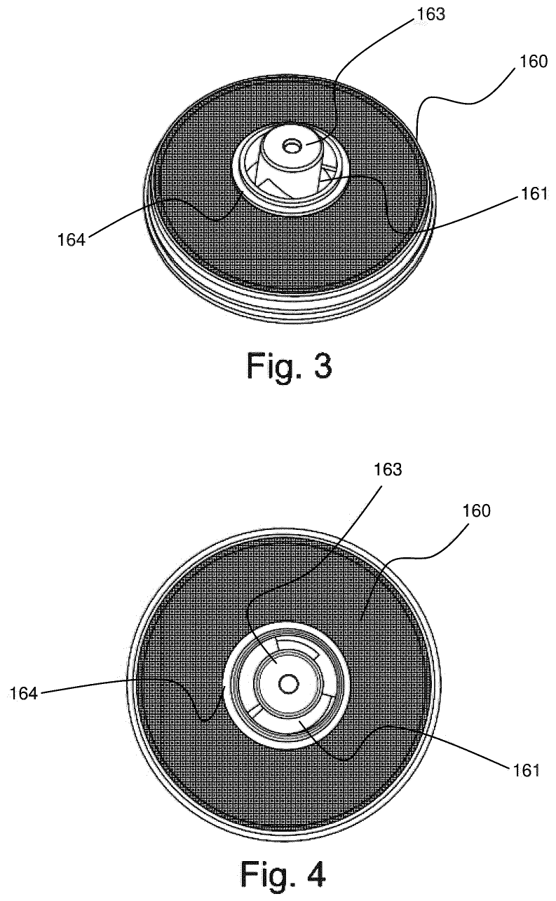

FIG. 3 shows a magnetic holder lid 160 for a holder usable for performing the method, said magnetic holder lid having a centre impeller portion 161. A dome part 163 forms the counter element to the magnetic bearing of the vessel lid. Said holder lid 160 can be attached to a holder by magnetic force from a closed cavity holding granular material. To enable said attachment to the holder the holder lid 160 and/or the holder comprises magnetic and/or metallic locking elements. Additionally shown is a gasket 164 sealing an impeller cap (not shown)

FIG. 4 shows another perspective of the holder lid 160 shown in FIG. 3. Said magnetic holder lid 160 having a centre impeller portion 161. A dome part 163 forms the counter element to the magnetic bearing of the vessel lid. Additionally shown is the gasket 164 sealing an impeller cap (not shown)

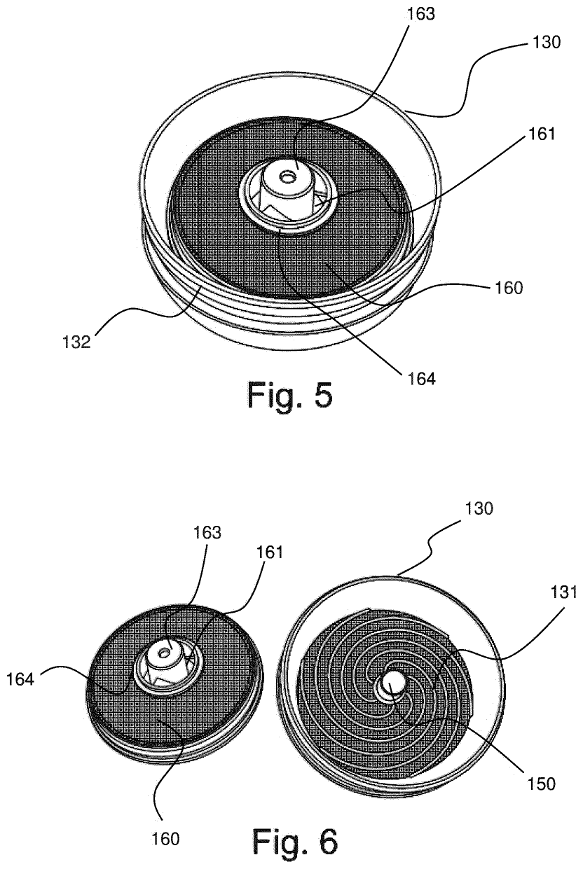

FIG. 5 shows the holder lid 160 as shown in Fid. 3 and 4 placed in the vessel lid 130 shown in FIGS. 1 and 2 attached to each other. The vessel lid 130 comprises the external threat 132, while the holder lid 160 comprises the impeller portion 161 and the dome portion 163. Additionally shown is the gasket 164 sealing a fluid guiding dome (not shown).

FIG. 6 shows the vessel lid 130 as shown in FIGS. 1 and 2 together with the holder lid 160 as shown in FIGS. 3 and 4 separated. The vessel lid 130 comprises the spiral elements 131 and the magnetic bearing 150. The holder lid 160 comprises the impeller portion 161 and the dome portion 163. Additionally shown is the gasket 164 sealing a fluid guiding dome (not shown).

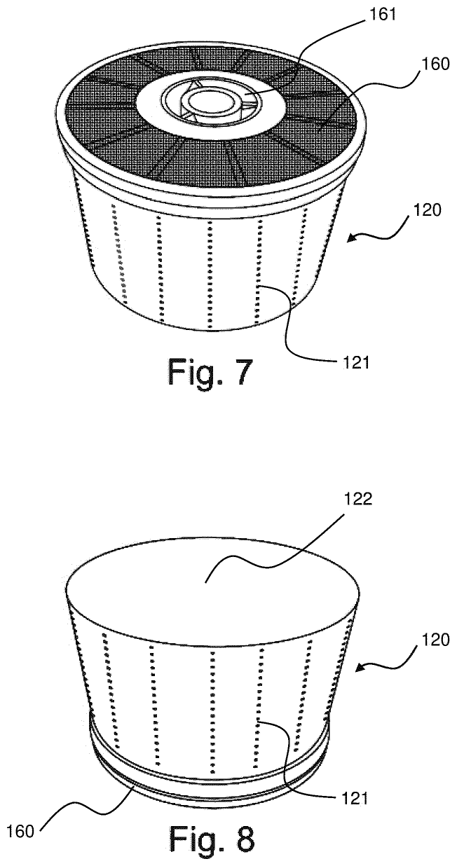

FIG. 7 shows a holder 120 usable for performing the method with the magnetic holder lid 160 placed on top in an upside-down position. In the centre the impeller portion 161 of the holder lid 160 is shown. The circular wall of the holder 120 is formed as a filter 121 which contains the granular material within the holder, while fluid can pass the filter 121.

FIG. 8 shows the holder 120 as shown in FIGS. 5 in an upright position with the magnetic holder lid 160 at the bottom. In this orientation the top 122 of the holder 120 is visible. The circular wall of the holder 120 is formed as a filter 121 which contains the granular material within the holder 120, while fluid can pass the filter 121. The top 121 may optionally from an additional filer.

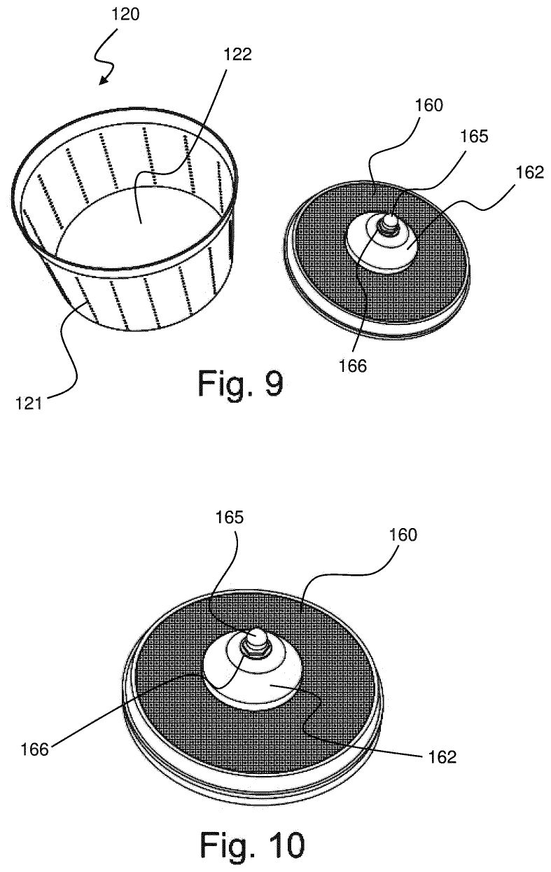

FIG. 9 shows the holder 120 and the magnetic holder lid 160 as shown in FIGS. 7 and 8 taken apart. In this orientation the top 122 of the holder 120 is visible, forming a bottom of the holder 120. The circular wall of the holder 120 is formed as a filter 121 which contains the granular material within the holder 120, while fluid can pass the filter 121. On the right side the holder lid 160 is shown. Said holder lid 160 comprises a fluid guiding dome 162 which is sealed towards the holder lid 160 by a gasket (not shown). The fluid guiding dome 162 is fixed to the dome part of the holder lid 160 by a cap nut 165. A washer 166 is placed between the cap nut 165 and the holder lid cap 162. The fluid guiding dome 162 is permeable for the fluid, so that fluid may enter into the holder 120 or exit the same through the impeller portion of the holder lid 160.

FIG. 10 shows the magnetic holder lid 160 as shown in FIGS. 3 and 4 with a fluid guiding dome 162 above the centre impeller portion 161. Said holder lid 160 comprises the fluid guiding dome 162 which is sealed towards the holder lid 160 by a gasket (not shown). The fluid guiding dome 162 is fixed to the dome part of the holder lid 160 by a cap nut 165. A washer 166 is placed between the cap nut 165 and the fluid guiding dome 162.

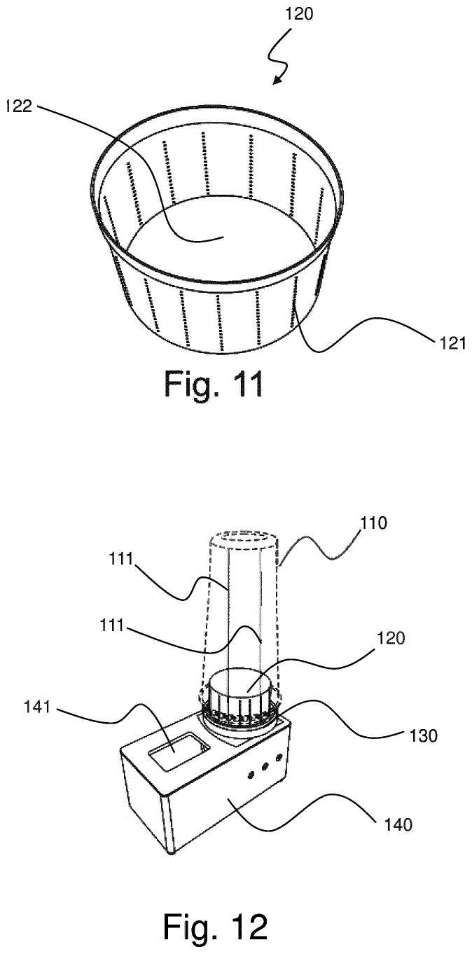

FIG. 11 shows an inside view into a holder 120 usable for performing the method. In this orientation the top 122 of the holder 120 is visible, forming a bottom of the holder 120. The circular wall of the holder 120 is formed as a filter 121 which contains the granular material within the holder 120, while fluid can pass the filter 121.

FIG. 12 shows a device 100 usable for performing the method, including a drive unit 140 with a control unit 141. A vessel 110 is fixed to the vessel lid 130. The holder 120 is arranged on the vessel lid 130 and placed within the vessel 110. The vessel 110 comprises ribs 111 to support and/or increase cascading of the fluid by causing turbulence within the fluid stream. The drive unit 140 as well as other parameters of the device 100 can be controlled by the control unit 141. The control unit 141 may comprise a display. Said display can be a touch display.

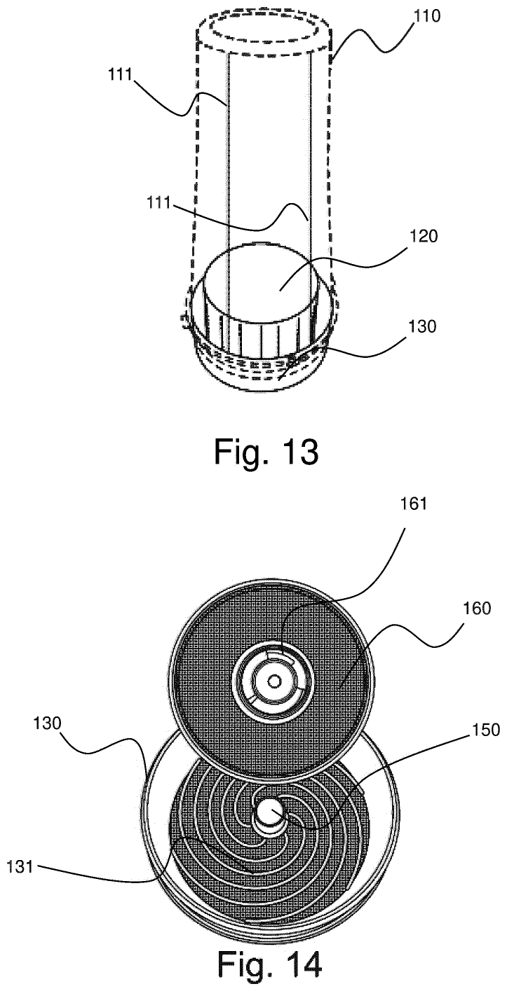

FIG. 13 shows the vessel 110 usable to perform the method with a holder 120 placed inside the vessel 110. The vessel 110 is fixed to the vessel lid 130. The holder 120 is arranged on the vessel lid 130 and placed within the vessel 110. The vessel 110 comprises ribs 111 to support and/or increase cascading of the fluid by causing turbulence within the fluid stream.

FIG. 14 shows an alternative view of the elements depicted in FIG. 6. The vessel lid 130 comprises the spiral elements 131 and the magnetic bearing 150. The holder lid 160 comprises the impeller portion 161 and the dome portion 163. Additionally shown is the gasket 164 sealing an fluid guiding dome (not shown).

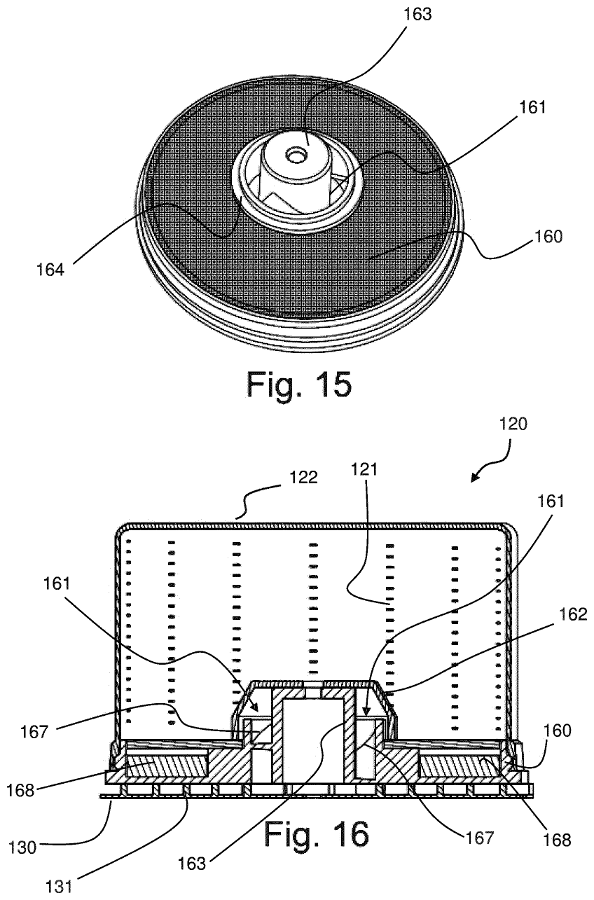

FIG. 15 shows an alternative view of the element depicted in FIGS. 3 and 4. The magnetic holder lid 160 having a centre impeller portion 161. A dome part 163 forms the counter element to the magnetic bearing of the vessel lid. Said holder lid 160 can be attached to a holder by magnetic force from a closed cavity holding granular material. To enable said attachment to the holder the holder lid 160 and/or the holder comprises magnetic and/or metallic locking elements. Additionally shown is a gasket 164 sealing an impeller cap (not shown).

FIG. 16 shows a cross-sectional view of the holder 120 and the holder lid 160 usable to perform the method. The holder 120 comprises a top 122, and a circular wall 121 which acts as filter. The top 122 optionally act as filter, too. The holder lid 160 comprises an impeller portion 161. Said impeller portion comprises impeller blades 167. The holder lid 160 further comprises a dome portion 163. Said dome portion 163 can act as a counterpart to a magnetic bearing (not shown) arranged on the holder lid 130. The holder lid 130 comprises spiral elements 131 for guiding fluid towards (or away from, depending on the direction of flow) the impeller portion 161 of the holder lid 160. Above the dome portion 163 of the holder lid 160 a fluid guiding dome 162 is arranged. Fluid can pass through said fluid guiding dome 162 into or out of the holder 120. The fluid guiding dome 162 is permeable for the fluid, so that fluid may enter into the holder 120 or exit the same through the impeller portion of the holder lid 160.

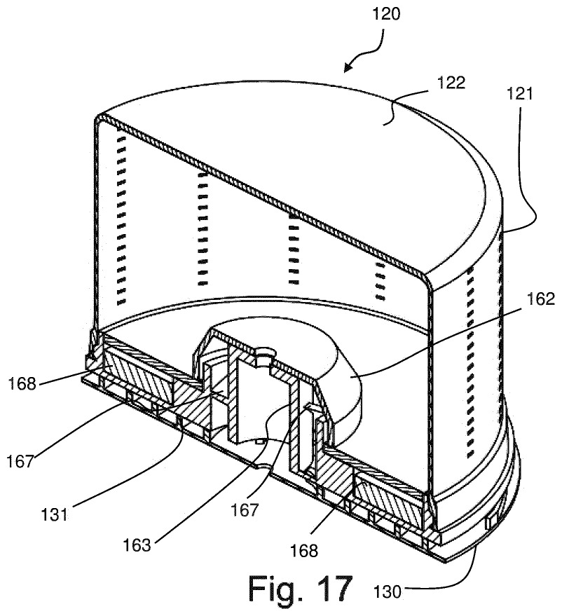

FIG. 17 shows an isometric cross-sectional view of the holder 120 and the holder lid 160 as shown in FIG. 15. The holder 120 comprises a top 122, and a circular wall 121 which acts as filter. The top 122 optionally act as filter, too. The holder lid 160 comprises an impeller portion 161. Said impeller portion comprises impeller blades 167. The holder lid 160 further comprises a dome portion 163. Said dome portion 163 can act as a counterpart to a magnetic bearing (not shown) arranged on the holder lid 130. The holder lid 130 comprises spiral elements 131 for guiding fluid towards (or away from, depending on the direction of flow) the impeller portion 161 of the holder lid 160. Above the dome portion 163 of the holder lid 160 a fluid guiding dome 162 is arranged. Fluid can pass through said fluid guiding dome 162 into or out of the holder 120.

What is disclosed is a method for dissolving or emulsifying compounds from a granular material using a fluid in a rotational fluidic device, the method comprising: providing a holder for said granular material, which holder has at least one inlet for receiving said fluid into at least a portion of said granular material and at least one outlet for discharging said fluid from at least a portion of said granular material; providing a vessel of a specific geometry to contain said fluid; providing at least one channel in proximity to said holder; providing rotational motion of said holder about an axis, wherein (a) said motion creates boundary and shear layers in said fluid, causing movement of at least a portion of said fluid within the at least one said channel; and (b) said movement causes at least a portion of said fluid to enter the at least one said inlet.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for dissolving and/or emulsifying compounds from a granular material using a fluid in a rotational fluidic device, the method comprising:
providing a holder for said granular material, which holder has at least one inlet for receiving said fluid into at least a portion of said granular material and at least one outlet for discharging said fluid from at least a portion of said granular material:
providing a vessel of a specific geometry to contain said fluid;
providing at least one channel in proximity to said holder;
providing rotational motion of said holder about an axis, wherein
(a) said motion creates boundary and/or shear layers in said fluid, causing movement of at least a portion of said fluid within the at least one said channel; and
(b) said movement causes at least a portion of said fluid to enter the holder by the at least one said inlet.

2-7. (canceled)

8. The method according to claim 1, wherein the fluid is water.

9. The method according to claim 1, wherein the granular material is coffee or tea.

10-12. (canceled)

13. The method according to claim 1, wherein the holder is rotated in a range between ≥500 rpm and ≤10,000 rpm, or between ≥1,000 rpm and ≤7500 rpm, or between ≥2,000 rpm and ≤6000 rpm.

14-17. (canceled)

18. The method according to claim 1, wherein the fluid pressure around the granular material is increased above ambient pressure.

19. The method according to claim 1, wherein the fluid rotation has a velocity in the range of between ≥0 m/s and ≤250 m/s, or between >0.5 m/s and ≤150 m/s, or between ≥1 m/s and ≤100 m/s.

20. (canceled)

21. The method according to claim 1, wherein the method comprises a process step to rotationally balance the granular material in the holder.

22-28. (canceled)

29. The method according to claim 1, wherein the fluid is aerated, preferably to create foam and/or changing temporally the density of an extraction and/or emulsion produced by the method.

30-34. (canceled)

35. A rotational fluidic device for dissolving and/or emulsifying compounds from a granular material, said device comprising a vessel and a holder; wherein the vessel is capable of holding a liquid and the holder is capable of holding the granular material and wherein the holder is arranged within the vessel; wherein the holder comprises at least one inlet for receiving said fluid into at least a portion of said granular material and at least one outlet for discharging said fluid from at least a portion of said granular material; wherein the vessel has a specific geometry to contain said fluid;
wherein the holder is capable to be put in rotational motion about an axis, and wherein the device comprises at least one channel in proximity to said holder.

36. The device according to claim 35, wherein the specific geometry of the vessel is conical, or comprising ribs or wherein the specific geometry of the vessel is a square.

37. (canceled)

38. The device according to claim 35, wherein the at least one channel in direction of gravity is located underneath the holder.

39. The device according to claim 35, wherein the holder is magnetically coupled to a drive mechanism and the motion of the holder is caused by said magnetic coupled drive mechanism.

40. (canceled)

41. The device according to claim 35, wherein the drive mechanism is a direct drive mechanism, and the motion is caused by said direct drive.

42. The device according to claim 35, wherein the inlets have impeller geometry, to drive fluid into the holder.

43. The device according to claim 35, wherein the vessel is capable to hold at least a partial a vacuum.

44. (canceled)

45. The device according to claim 35, wherein the device comprises a heater capable of heating the fluid or wherein the heater is an inductive heater.

46. (canceled)

47. The device according to claim 35, wherein the holder wall is and/or comprises a filter capable of filtering the fluid through the wall of the holder.

48. The device according to claim 35, wherein the inlet is in the top of the holder.

49. The device according to claim 35, wherein the vessel is capable of holding a pressure increased above ambient pressure.

50. The device according to claim 35, wherein the fluid forms or is at least part of the bearing of the holder and/or wherein the device comprises a magnetic bearing for the holder.

51. (canceled)

52. The device according to claim 35, wherein the drive is arranged above the holder, i.e. in direction of gravity the holder is arranged underneath the drive or wherein the drive is arranged below the holder, i.e. in direction of gravity the holder is arranged above the drive.

53. (canceled)

54. The device according to claim 52, wherein the drive is integrated below a countertop.

55. The device according to claim 35, wherein a geometry is fixed in the centre diverting some flow of the fluid.

56. The device according to claim 35, wherein the holder contains at least one valve to increase pressure and/or seal the holder towards the vessel at stop.

57. The device according to claim 56 wherein the valve is activated by rotational speeds.

58. The device according to claim 35, wherein the vessel has inlet and/or outlet valves.

59. The device according to claim 35, wherein the vessel comprises a gas inlet to aerate the fluid.

60. The device according to claim 35, wherein the vessel has a draining valve, preferably or a tap-like draining valve.

61. The device according to claim 35, wherein the device comprises means to monitor the temperature of the fluid and/or the granular material.

62. The device according to claim 35, wherein the at least one channel is formed by a spiral element.
